(19) United States
(12) Patent Application Publication
(10) Pub. No.: US 2024/0103478 A1
(43) Pub. Date: Mar. 28, 2024

(54) Validation Logic for OPC UA Connected Devices

(71) Applicant: ABB Schweiz AG, Baden (CH)

(72) Inventors: Roland Braun, Niederkassel Lülsdorf (DE); Mario Hoernicke, Landau (DE)

(73) Assignee: ABB Schweiz AG, Baden (CH)

(21) Appl. No.: 18/527,613

(22) Filed: Dec. 4, 2023

Related U.S. Application Data
(63) Continuation of application No. PCT/EP2022/064095, filed on May 24, 2022.

(30) Foreign Application Priority Data
Jun. 2, 2021 (EP) 21177460.9

(51) Int. Cl. G05B 19/05

(52) U.S. Cl. CPC G05B 19/056; G05B 19/058; G05B 2219/34263

(57) ABSTRACT

A method performed by an OPC UA client includes importing a node set file pertaining to an OPC UA-enabled automation device, the nodeset file defining validation logic used to validate data to be written to the automation device; preparing data to be written to the automation device; and using the validation logic to validate the prepared data. An alternative method includes importing a nodeset file pertaining to an automation device in which a OPC UA server is embedded, the nodeset file defining validation logic used to validate data to be written to the automation device; receiving data to be written to the automation device; and using the validation logic to validate the received data.

### CROSS-REFERENCE TO RELATED APPLICATIONS

The instant application claims priority to International Patent Application No. PCT/EP2022/064095, filed May 24, 2022, and to European Patent Application No. 21177460.9, filed Jun. 2, 2021, each of which is incorporated herein in its entirety by reference.

### FIELD OF THE DISCLOSURE

The disclosure relates to validation logic for OPC UA-connected devices.

### BACKGROUND OF THE INVENTION

Automated industrial plants typically comprise many field devices for implementing an industrial production process. Field devices are controlled by process controllers forming part of a distributed control system (DCS). Fieldbus communication interfaces are used to connect the field devices to the process controllers. Field devices are continually growing in functionality, resulting in complex parameter sets and complex device descriptions involving exhaustive conditional constraints on the circumstances under which parameters are used. Parameter settings may be interdependent: a modification to one parameter often requires a setting to be validated in combination with other settings. Validation logic that is intended to protect the integrity of the device settings is typically embedded within the firmware of the field device itself.

The validation logic may be implemented in various ways. Fieldbus standards (such as FF, HART, PROFIBUS) allow use of the standardized Electronic Device Description Language (EDDL, as specified by IEC 61804) to enable engineering tools to manage device parameters. Equally, the Field Device Tools (FDT) standard, IEC 62453, allows field device suppliers to offer a Device Type Manager (DTM) for managing device parameters.

The drawback of these solutions is the duplicated effort involved in implementing the validation logic as EDDL-implemented or DTM-implemented logic. Moreover, the use of EDDL is possible only in conjunction with an EDD interpreter that is costly to maintain.

Many “industry 4.0” concepts assume that field device connectivity will be implemented in the future using the Open Platform Communications Unified Architecture (OPC UA). The current solutions based on EDDL/FDT do not suit field devices that will implement OPC UA as their main form of connectivity. Future field devices comprising OPC UA servers will be described by means of an XML schema called a nodeset file. A nodeset file describes the address space of the field device. An OPC UA client can import the nodeset file to discover how to interact with the field device by reading/writing data or invoking methods.

### BRIEF SUMMARY OF THE INVENTION

There is therefore a need for improvements in the validation of parameter settings of a field device of an industrial automation system. This need is met by the subject-matter of the independent claims. Optional features are set forth by the dependent claims.

According to a first aspect, there is provided a method performed by an OPC UA client. The method comprises: importing a nodeset file pertaining to an OPC UA-enabled automation device, the nodeset file defining validation logic used to validate data to be written to the automation device; preparing data to be written to the automation device; and using the validation logic to validate the prepared data.

Validating the prepared data may comprise validating settings in the address space of the automation device. By “automation device” is meant in particular a field device or an instrument device but the automation device could be any OPC UA-enabled device.

The method may further comprise writing the validated data to the automation device. In one example, the data is written to the automation device during integration of the automation device into an automated industrial plant. In another example, the data is written to the automation device to convert parameters according to a first standard to parameters according to a second standard, wherein the first and second standards are mutually incompatible.

It will be understood that the data may prepared and validated in this way in the absence of the automation device. In one advantageous example, the data is prepared before an OPC UA server of the automation device has been deployed. Stated differently, the data may be prepared without the OPC client necessarily being connected to the automation device.

The present disclosure thus proposes to add PYTHON script-described business logic to nodeset files that enables a generic approach to validating settings in the address space of an OPC UA-connected field device without necessarily being connected to the field device. An OPC UA client having knowledge of a convention specifying where the validation logic is stored, and how to invoke and handle the execution of the validation logic, can prepare valid datasets for absent field devices. Storing the validation logic in the nodeset file in this way reduces the effort needed to create and maintain the logic that protects the logical integrity of device's data settings. Furthermore, the logic executed in the OPC UA client may be the same as that used in the OPC UA server, meaning the logic needs to be written only once. The effort needed to provide a runtime environment in a device management tool is thereby reduced. The nodeset file may furthermore be used in a way akin to a digital twin representing the device. Additionally, maintenance of the runtime environment using such validation logic, particularly when implemented as scripted logic, is easier than the maintenance of an EDD interpreter.

According to a second aspect, there is provided a method performed by an OPC UA server. The method comprises: importing a nodeset file pertaining to an automation device in which the OPC UA server is embedded, the nodeset file defining validation logic used to validate data to be written to the automation device; receiving data to be written to the automation device; and using the validation logic to validate the received data.

The OPC UA server may be an aggregating server. By deploying the validation logic to an aggregating server, other devices such as the client device and aggregated servers may be kept as simple as possible.

In the method of the second aspect, the automation device may operate according to a first standard that requires a first variable to be used to trigger a service and a second variable to be used as a status variable for reporting the status of the service, wherein the validation logic is configured to represent the first and second variables using a single, third variable according to a second standard that is incompatible with the first standard. In that case, the validation logic may comprise status logic and trigger logic, wherein the trigger logic is configured to monitor changes to the third variable and to write, in response to a detected change, a trigger to the first variable, and wherein the status logic is configured to monitor the second variable and to write status changes in the second variable to the third variable. In this way, the validation logic can be used to bridge between mutually incompatible standards.

By “validation logic” is meant logic that is intended to protect the integrity of the device settings and may alternatively be referred to as “integrity protection logic”. In some implementations, the validation logic may implement so-called “business logic”, which is to be understood within the context of the present disclosure as logic pertaining to the parameters or settings of the OPC UA-enabled device, and not to a method of doing business. A “parameter” may also be referred to as an “attribute”.

In any aspect, the validation logic may be implemented using a PYTHON script or using any other appropriate language, especially scripting languages.

### BRIEF DESCRIPTION OF THE SEVERAL VIEWS OF THE DRAWING(S)

FIG. 1 illustrates a configuration of a field device according to a first example in accordance with the disclosure.

FIG. 2 illustrates a configuration of a field device according to a second example in accordance with the disclosure.

FIG. 3 shows a non-hierarchical, asymmetric reference type for variables in accordance with the disclosure.

FIG. 4 shows a script targeted by a reference of the type shown in FIG. 3.

FIG. 5 illustrates a nodeset integrity protection concept in accordance with the disclosure.

FIG. 6 illustrates one example use case involving scripted parameter validation performed in relation to a field device following the OPC UA specified PA-DIM Model in accordance with the disclosure.

FIG. 7 illustrates a further example use case involving bridging to IEC 61499 in accordance with the disclosure.

FIG. 8 illustrates a computing device that can be used in accordance with the devices and methods disclosed herein.

### DETAILED DESCRIPTION OF THE INVENTION

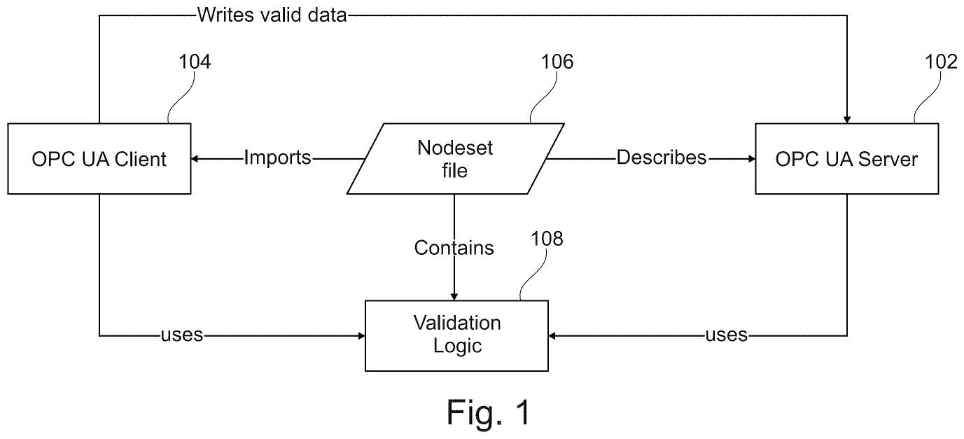

FIG. 1 illustrates the configuration or parameterisation of a field device according to a first example. The field device (not shown) comprises an OPC UA server 102. As used herein, OPC UA refers to OPC Unified Architecture (OPC UA), which is a machine-to-machine communication protocol used for industrial automation and developed by the OPC Foundation, as the term is well known in the art. The OPC UA platform is a platform-independent service-oriented architecture that integrates individual OPC Classic specifications into an extensible framework. OPC UA is a platform-independent, service-oriented client-server architecture that transports data such as control values, measurement values, and parameters, and which semantically describes the data. The OPC UA server 102 receives and exposes such data from the field device. The OPC UA server 102 supports information models which define how the data is typed and classified. The representation of the exposed data is called the address space.

An OPC UA client 104 is in communication with the OPC UA server 102. The OPC UA client 104 may be an application that connects to the OPC UA server 102. The OPC UA client 104 may be used, for example, to find data from the address space of the OPC UA server 102, to read and write server data, to subscribe to certain data changes or events such as alarms, and to call server methods. Communication between the OPC UA server 102 and the OPC UA client 104 is handled by services.

The OPC UA server 102 is described by a nodeset file 106. The nodeset file 106 provides a mechanism for data exchange in the OPC UA environment and may take the form of an XML file. The nodeset file 106 describes the address space of the OPC UA server 102.

According to the present disclosure, the nodeset file 106 further comprises validation logic 108 for ensuring the logical integrity of the device settings. The validation logic 108 may comprise PYTHON script-described logic added to the nodeset file 106 to enable a generic approach to validating settings in the address space of the OPC UA server 102 of the field device without necessarily being connected to that device. Various ways of integrating the logic into the nodeset file 106, along with examples of suitable validation logic, are described below.

To configure the field device, the OPC UA client 104 imports the nodeset file 106 to discover how to interact with the field device. During the configuration, the OPC UA client 102 uses the validation logic 108 to ensure the validity of data that is written to the OPC UA server 102 of the field device.

The OPC UA server 102 similarly uses the validation logic 108 to validate the data.

In this way, the OPC UA client 104, being able to import the validation logic 108 and knowing how to invoke and handle the execution of the scripted logic, can prepare a valid dataset for the field device, even in the absence of the field device.

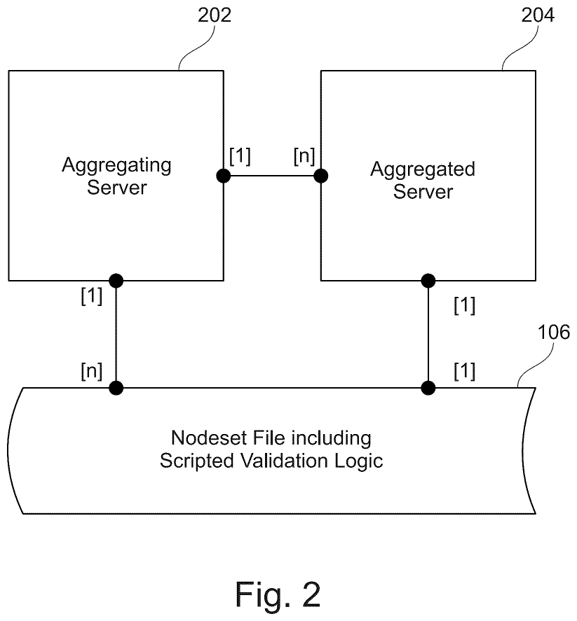

FIG. 2 illustrates the configuration of a field device according to a second example in which the OPC UA system is organized according to an aggregation architecture involving an aggregating server 202 and at least one aggregated server 204. The aggregated server 204 is the OPC UA server of an entity of the automation system such as a field device. The aggregating server 202 connects to each underlying aggregated server 204 via OPC UA services and aggregates its type, instance, and structure information. Thus, a single server can be used to connect to multiple other servers and to represent their information in a unified manner In this way, a client connecting to the aggregating server 202 can access the data of multiple aggregated servers 204 from a single source. In this example, the validation logic 108 is executed only by the aggregating server 202, such that generic OPC UA clients may be used. In this way, the OPC UA client may be implemented on a resource-limited device that is unable to run scripted logic because of the resource consumption of a script interpreter. The notation in FIG. 2 (following UML graphical syntax) indicates the number of instances possible in the depicted relation. Thus, there is one (“[1]”) aggregating server 202 that can aggregate multiple (“[n]”) OPC UA servers as aggregated servers 204. For the sake of the brevity and regarding the application of scripted logic, each of the aggregated OPC UA servers (“[1]”) is described by one (“[1]”) nodeset file 106, although it will be understood that the present disclosure is not so limited. Therefore, the single (“[1]”) aggregating server 202 can handle multiple (“[n]”) nodeset files 106 relating respectively to the aggregated OPC UA servers 204. It will be understood that some aggregated servers 204 may not need any additional validation logic and can be aggregated by browsing their address spaces.

In any of the examples described herein, the validation logic 108 may be incorporated into the nodeset file 106 in any one of various suitable ways.

According to a first implementation, the validation logic 108 is embodied as a PYTHON script and stored in the nodeset file 106 in the XML element designated “Extension”, which can refer for example to vendor specific schemata. In this implementation, the OPC UA client is configured to identify the extension that contains the scripted function. This identification may be performed according to an established convention. Similarly, the OPC UA server may leverage the same validation logic 108 to protect the logical integrity of data. Advantageously, the effort required to provide the validation logic for protecting the logical integrity of data is reduced, since the validation logic needs to be written only once. A further advantage of this implementation is its ability to hide the validation logic.

According to a second implementation, the PYTHON script is stored in the nodeset file 106 using the value attribute of the description of a UAVariable. In this implementation, the OPC UA client is configured to identify the UAVariable that contains the scripted function. This identification may again be performed according to an established convention. The advantage as compared to the first implementation is that the second implementation supports debugging (inspection) of scripted functions on the OPC UA server. Moreover, an OPC UA client can import the validation logic 108 from the OPC UA server immediately if there is no nodeset file available. (Since the nodeset file 106 represents at least a part of the address space, the approach of providing the scripted logic in the value of a variable makes the script available either by means of reading the nodeset file 106 or reading (e.g., via the OPC UA Read Service) the value of the variable. The scripted logic 108 may enter the OPC UA server's address space in any appropriate manner.) A further advantage is that, if the UAVariable is write-enabled, the PYTHON script may be modified.

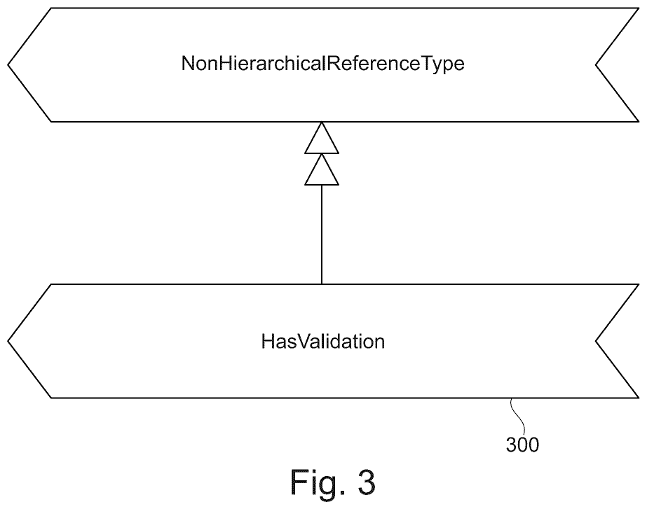

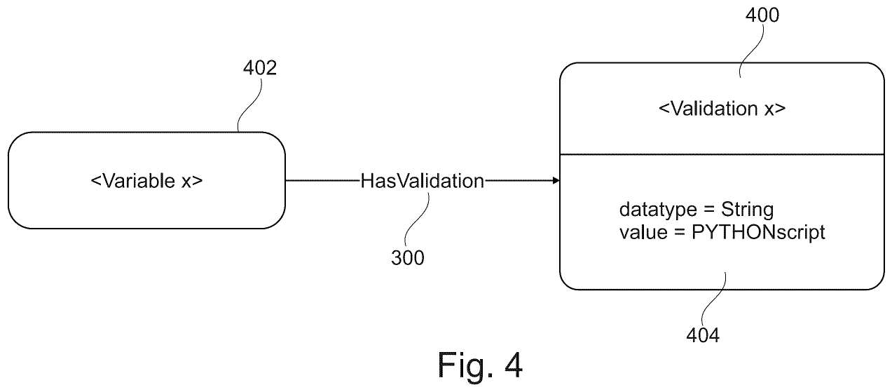

In the second implementation, an information model may be created using a reserved namespace to avoid conflicts with other application-specific content of the address space. The reserved name space defines a non-hierarchical, asymmetric reference type 300 named “HasValidation”, for example, as shown in FIG. 3. The inverse name may be “Validates”. A reference of type “HasValidation” targets a variable 400 storing the PYTHON script 404 in a string, as shown in FIG. 4. In this way, any writable element in the address space can refer to the validation logic 108. If a value is written for a variable 402 that refers to the validation logic 108, by virtue of the variable having the type “HasValidation” 300, the OPC UA client can load and execute the PYTHON script 404. The OPC UA client 104 provides an execution environment comprising a PYTHON script interpreter and a call back interface that enables reading and writing of other data of the address space. According to the established convention, the PYTHON validating script 404 sets an output flag indicating the result of the integrity check. Furthermore, the same script 404 may executed inside the device embedded OPC UA server 102, with the result of that script execution being reflected in a further status variable. In this way, execution of the validation logic is triggered post-write.

The information model may furthermore establish a convention defining how a PYTHON script such as 404 can access variables of the address space. The script 404 may be enabled according to the convention to collect data needed for the validation and/or to fix settings and to indicate the validity of the data set.

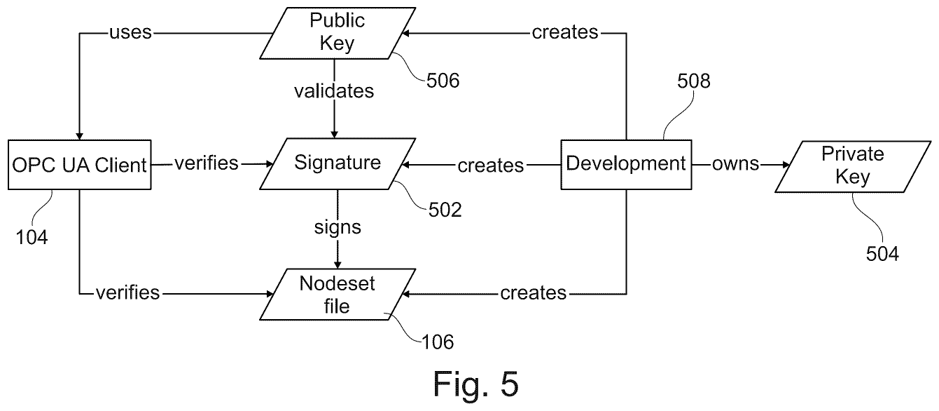

FIG. 5 illustrates the nodeset integrity protection concept. Asymmetric cryptography methods like a PKI can be used to protect the nodeset file 106 against illicit modifications, since the PYTHON script 404 may present a target for attackers. The nodeset file 106 may be protected using a signature 502 that is created with a private key 504, while the same signature 502 and the content of the nodeset file 106 can be validated with a public key 506. The private key 504 and public key 506, as well as the nodeset file 106, are created during development 508 of the OPC UA server 102. The private key 504 is kept in a safe place. The public key 506 is inferred from the private key 504. The private key 504 is used to encrypt the signature 502 of the nodeset file 106. The signature 502 hashes the nodeset file 106 so as to represent a compressed form of the content of the nodeset file 106.

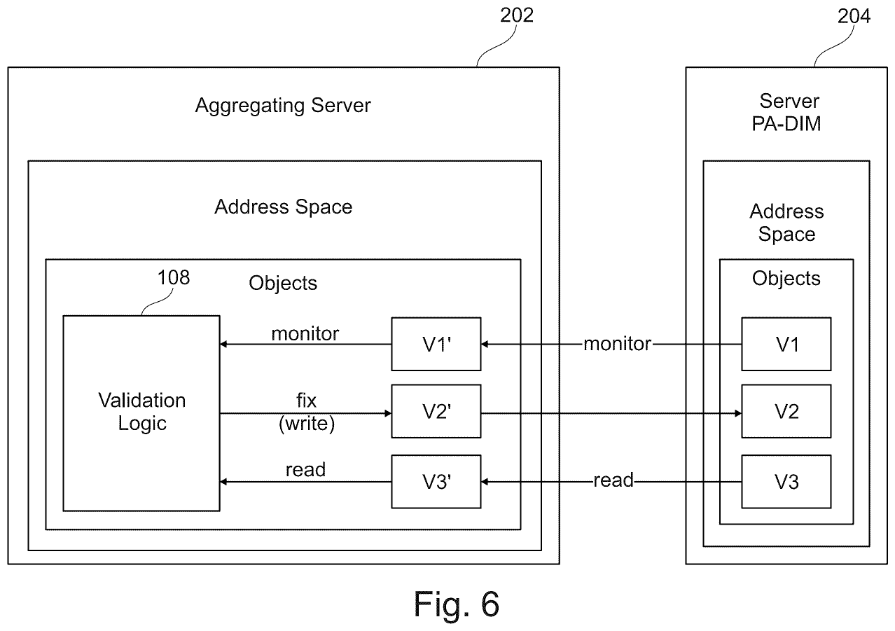

FIG. 6 illustrates one example use case involving scripted parameter validation performed in relation to a field device following the OPC UA specified PA-DIM Model. The field device (not shown) runs using a parameter set in which the parameter V2 depends on the values of parameters V1 and V3, i.e., V2=f (V1, V3). The aggregating server 202 aggregates the parameters of the field device by representing them using the proxy parameters V1′, V2′ and V3′. The validation logic 108 is configured to monitor changes in parameter V1′, which monitors the changes in the aggregated parameter V1. If V1 changes,

V1′ change as well, which triggers the execution of the validation logic 108. Since V2 depends on the values of parameters V1 and V3, the validation logic 108 reads the value of parameter V3 through its proxy parameter V3′. The validation logic 108 calculates V2′ and writes a new value to V2′ which is in turn forwarded to V2.

Aside from the device integration examples described above, write-triggered validation logic can be used to bridge between control applications that are incompatible by their design principles.

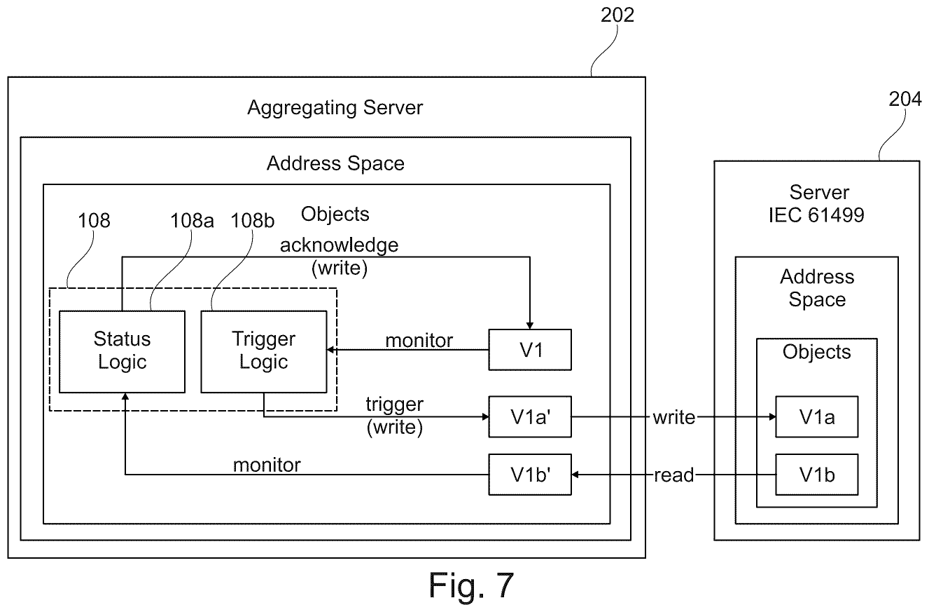

FIG. 7 illustrates a further example use case involving bridging to IEC 61499. According to IEC 61499, control functions (services) are triggered by writing one variable (“Event”) and the status of completion is reported through a separate variable (“Feedback”). In contrast, according to VDI 2658, a control function (state-machine) is managed by means of a single variable that is written to trigger an execution and the status feedback is communication through the same variable. Under the different design principles, a programmable logic controller (PLC) applying IEC 61499 cannot be used in a modular automation system that applies VDI 2658. While VDI 2858 runs on OPC UA, the aggregating OPC UA server 202 implementing validation logic 108 as described herein can be configured to bridge between the different standards (VDI2658/IEC 61499). The address space of the aggregating server 202 represents a VDI 2658 defined service object with the control & status variable (V1). This variable V1 is used to represent (aggregate) the control objects of the OPC UA server 204 of another PLC that follows IEC 61499, in which one variable (Via) is used to trigger a service while another variable (V1b) is used as the status reporting variable. Variables V1a′ and V1b′ are aggregated representations of variables V1 and V1b, respectively. The validation logic 108 in this case comprises status logic 108a and trigger logic 108b. The trigger logic 108b monitors changes to variable V1 and writes the resulting trigger to the proxy variable V1a′, to be forwarded to the aggregated variable V1a. The status logic 108a monitors the proxy variable V1b′ for changes made in the aggregated status variable V1b and writes status changes on variable V1b′ to the variable V1.

The approaches described herein can be extended towards the application logic of the automation device, for example to parts of the firmware comprising logic relating to I/O functions dealing with the hardware specifics, protocol stacks, generic math libraries, etc.

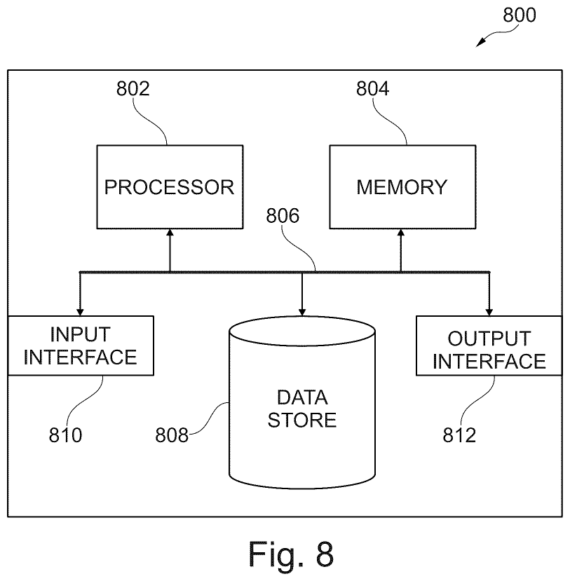

Referring now to FIG. 8, a high-level illustration of an exemplary computing device 800 that can be used in accordance with the systems and methodologies disclosed herein is illustrated. The computing device 800 includes at least one processor 802 that executes instructions that are stored in a memory 804. The instructions may be, for instance, instructions for implementing functionality described as being carried out by one or more components discussed above or instructions for implementing one or more of the methods described above. The processor 802 may access the memory 804 by way of a system bus 806. In addition to storing executable instructions, the memory 804 may also store conversational inputs, scores assigned to the conversational inputs, etc.

The computing device 800 additionally includes a data store 808 that is accessible by the processor 802 by way of the system bus 806. The data store 808 may include executable instructions, log data, etc. The computing device 800 also includes an input interface 810 that allows external devices to communicate with the computing device 800. For instance, the input interface 810 may be used to receive instructions from an external computer device, from a user, etc. The computing device 800 also includes an output interface 812 that interfaces the computing device 800 with one or more external devices. For example, the computing device 800 may display text, images, etc. by way of the output interface 812.

It is contemplated that the external devices that communicate with the computing device 800 via the input interface 810 and the output interface 812 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 800 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 800 may be a distributed system. Thus, for instance, several devices may be in communication by way of a network connection and may collectively perform tasks described as being performed by the computing device 800.

Various functions described herein can be implemented in hardware, software, or any combination thereof. If implemented in software, the functions can be stored on or transmitted over as one or more instructions or code on a computer-readable medium. Computer-readable media include computer-readable storage media. Computer-readable storage media can be any available storage media that can be accessed by a computer. By way of example, and not limitation, such computer-readable storage media can comprise FLASH storage media, RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

It will be appreciated that the aforementioned circuitry may have other functions in addition to the mentioned functions, and that these functions may be performed by the same circuit.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features.

It is noted that embodiments of the invention are described with reference to different categories. In particular, some examples are described with reference to methods whereas others are described with reference to apparatus. However, a person skilled in the art will gather from the description that, unless otherwise notified, in addition to any combination of features belonging to one category, also any combination between features relating to different category is disclosed by this application. However, all features can be combined to provide synergetic effects that are more than the simple summation of the features.

While the invention has been illustrated and described in detail in the drawings and foregoing description, such illustration and description are to be considered exemplary and not restrictive. The invention is not limited to the disclosed embodiments. Other variations to the disclosed embodiments can be understood and effected by those skilled in the art, from a study of the drawings, the disclosure, and the appended claims. The word “comprising” does not exclude other elements or steps. The indefinite article “a” or “an” does not exclude a plurality. In addition, the articles “a” and “an” as used herein should generally be construed to mean “one or more” unless specified otherwise or clear from the context to be directed to a singular form.

A single processor or other unit may fulfil the functions of several items recited in the claims. The mere fact that certain measures are recited in mutually different dependent claims does not indicate that a combination of these measures cannot be used advantageously.

A computer program may be stored/distributed on a suitable medium, such as an optical storage medium or a solid-state medium supplied together with or as part of other hardware, but may also be distributed in other forms, such as via the internet or other wired or wireless communications systems.

Any reference signs in the claims should not be construed as limiting the scope.

Unless specified otherwise, or clear from the context, the phrase “A and/or B” as used herein is intended to mean all possible permutations of one or more of the listed items. That is, the phrase “X comprises A and/or B” is satisfied by any of the following instances: X comprises A; X comprises B; or X comprises both A and B.

The validation logic in accordance with embodiments of the disclosure may be stored in an appropriate manner in the nodeset file. In one example, the validation logic is stored in the nodeset file in a predetermined XML element, with the method of the first or second aspect further comprising identifying the element that contains the validation logic according to an established convention. Alternatively, in a second example, the validation logic may be stored in the nodeset file using a value attribute of a description of a UAVariable, the method of the first or second aspect further comprising identifying the UAVariable that contains the validation logic according to an established convention. Thus, the convention provides OPC UA clients and servers with the requisite knowledge concerning the location of the validation logic in the nodeset file.

In any aspect, validating the data may comprise using an information model to identify that a variable to be written is of a type that indicates a validation requirement, and executing the validation logic in relation to the variable to be written in response to the identifying. In that case, the information model may further define a status variable for carrying the result of the validation, the method further comprising modifying the status variable to indicate the result of executing the validation logic in relation to the variable to be written.

In any aspect, the validation logic may be stored in the nodeset file in encrypted form, for improved security against attackers seeking to target the validation logic.

According to a third aspect, there is provided a method comprising: creating the nodeset file as described in relation to the first and second aspects.

Any of the methods described herein may furthermore comprise the step of implementing/performing/controlling an industrial manufacturing process using an industrial automation system comprising the said automation device to which data has been written. Any of the methods may comprise the preceding step of integrating the said automation device into the industrial automation system.

According to a fourth aspect, there is provided a computer-readable data carrier or a data carrier signal carrying the nodeset file created using the method of the third aspect.

According to a fifth aspect, there is provided a computing device comprising a processor configured to perform the method of any of the first, second, and third aspects.

According to a sixth aspect, there is provided a computer program product comprising instructions which, when executed by a computing device, enable or cause the computing device to perform the method of any of the first, second, and third aspects.

According to a seventh aspect, there is provided a computer-readable data carrier or a data carrier signal carrying instructions which, when executed by a computing device, enable, or cause the computing device to carry out the method of any of the first, second, and third aspects.

The invention may include one or more aspects, examples, or features in isolation or combination whether or not specifically disclosed in that combination or in isolation. Any optional feature or sub-aspect of one of the above aspects applies as appropriate to any of the other aspects.

These and other aspects of the invention will be apparent from and elucidated with reference to the embodiments described hereinafter.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method performed by an OPC UA client, the method comprising:
importing a nodeset file pertaining to an OPC UA-enabled automation device, the nodeset file defining validation logic used to validate data to be written to the automation device;
preparing data to be written to the automation device; and
using the validation logic to validate the prepared data.

2. The method of claim 1, wherein the data is prepared before an OPC UA server of the automation device has been deployed.

3. The method of claim 1, wherein the validation logic is implemented using a PYTHON script.

4. The method of claim 1, wherein the validation logic is stored in the nodeset file in a predetermined XML element, the method further comprising identifying the element that contains the validation logic according to an established convention.

5. The method of claim 1, wherein the validation logic is stored in the nodeset file using a value attribute of a description of a UAVariable, the method further comprising identifying the UAVariable that contains the validation logic according to an established convention.

6. The method of claim 1, wherein validating the data comprises using an information model to identify that a variable to be written is of a type that indicates a validation requirement and executing the validation logic in relation to the variable to be written in response to the identifying.

7. The method of claim 6, wherein the information model further defines a status variable for carrying the result of the validation, the method further comprising modifying the status variable to indicate the result of executing the validation logic in relation to the variable to be written.

8. A method performed by an OPC UA server, the method comprising:
importing a nodeset file pertaining to an automation device in which the OPC UA server is embedded, the nodeset file defining validation logic used to validate data to be written to the automation device;
receiving data to be written to the automation device; and
using the validation logic to validate the received data.

9. The method of claim 8, wherein the OPC UA server is an aggregating server.

10. The method of claim 9, wherein the automation device operates according to a first standard that requires a first variable to be used to trigger a service and a second variable to be used as a status variable for reporting the status of the service, wherein the validation logic is configured to represent the first and second variables using a single, third variable according to a second standard that is incompatible with the first standard.

11. The method of claim 10, wherein the validation logic comprises status logic and trigger logic, wherein the trigger logic is configured to monitor changes to the third variable and to write, in response to a detected change, a trigger to the first variable, and wherein the status logic is configured to monitor the second variable and to write status changes in the second variable to the third variable.

12. The method of claim 3, wherein the validation logic is implemented using a PYTHON script.

13. The method of claim 3, wherein the validation logic is stored in the nodeset file in a predetermined XML element, the method further comprising identifying the element that contains the validation logic according to an established convention.

14. The method of claim 3, wherein the validation logic is stored in the nodeset file using a value attribute of a description of a UAVariable, the method further comprising identifying the UAVariable that contains the validation logic according to an established convention.

15. The method of claim 3, wherein validating the data comprises using an information model to identify that a variable to be written is of a type that indicates a validation requirement and executing the validation logic in relation to the variable to be written in response to the identifying.

16. The method of claim 15, wherein the information model further defines a status variable for carrying the result of the validation, the method further comprising modifying the status variable to indicate the result of executing the validation logic in relation to the variable to be written.

17. The method of claim 3, wherein the validation logic is stored in the nodeset file in encrypted form.

18. A method comprising using a control device to create a nodeset file pertaining to an OPC UA-enabled automation device, the nodeset file defining validation logic used to validate data to be written to the OPC UA-enabled automation device.
